(19) United States
(12) Patent Application Publication
(10) Pub. No.: US 2022/0036761 A1
(43) Pub. Date: Feb. 3, 2022

(54) AUGMENTED REALITY ASSISTED TRAINING

(71) Applicant: Virginia Commonwealth University, Richmond, VA (US)

(72) Inventors: Jill B. Ware, Richmond, VA (US); John Henry Blatter, Richmond, VA (US)

(21) Appl. No.: 17/414,309

(22) PCT Filed: Jan. 31, 2020
(86) PCT No.: PCT/US2020/016085

§ 371 Date: Jun. 15, 2021

Related U.S. Application Data
(60) Provisional application No. 62/801,856, filed on Feb. 6, 2019.

(51) Int. Cl. G09B 19/00; G06T 19/00; G06T 15/20; G06F 3/01; G09B 5/02

(52) U.S. Cl. CPC G09B 19/0038; G06T 19/006; G09B 5/02; G06F 3/011; G06T 15/205

(57) ABSTRACT

Disclosed are various approaches for using augmented reality to assist in the training of individuals. A computing device can be configured to receive a video recording captured by camera mounted to a first user, the video recording comprising a plurality of body movements of the first user. The computing device can then generate a virtual reality model from the video recording. Subsequently, the computing device can send the virtual reality model to a virtual reality headset mounted to a second user. The virtual reality headset of the second user can then display a first person perspective of the motions of the first user for the second user to match with his or her own body movements.

### CROSS-REFERENCE TO RELATED APPLICATIONS

This application claims priority to, and the benefit of, U.S. Provisional Patent Application No. 62/801,856, entitled “AUGMENTED REALITY ASSISTED TRAINING” and filed on Feb. 6, 2019.

### BACKGROUND

Instructors often have difficulty conveying proper technique to students. Students may attempt to imitate the movement an instructor makes. However, the student may not be able to see every aspect of a body movement. For example, a student attempting to copy a golf stroke may observe the large motions, but fail to recognize the small motions that the instructor performs to successfully swing a golf club. As another example, a dance student my observe the general motion of a dance move, but overlook the subtle motions or aspects of the instructor's performance of the dance move. Similarly, an instructor may have difficulty observing the portions of a student's body movement that are incorrect.

Differences in perspective can also make it more difficult for a student to learn proper techniques from an instructor. For example, if a student is mirroring an instructor who is facing the student, the student will have to compensate. Motions performed by the instructor's left side of the body will have to be performed by the student's right side. Moreover, a student standing in front of the instructor cannot see what is going on behind the instructor. Likewise, a student standing behind the instructor cannot see what is going on in front of the instructor. As a result, a student standing in front of the instructor may be unable to observe how the instructor is bending his or her back or moving his or her heels. Likewise, a student standing behind the instructor may not be able to observe what the instructor is doing with his or her hands or forearms. An instructor faces similar difficulties when evaluating a student.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing of an implementation of an embodiment of the present disclosure.

FIG. 3 is a drawing of an implementation of an embodiment of the present disclosure.

FIG. 4 is a flowchart illustrating one example of functionality implemented as portions of an application or method according to various embodiments of the present disclosure.

FIG. 5 is a flowchart illustrating one example of functionality implemented as portions of an application or method according to various embodiments of the present disclosure.

FIG. 6 is a schematic block diagram that provides one example illustration of a computing device used to implement the methods depicted in FIGS. 4 and 5 according to various embodiments of the present disclosure.

### DETAILED DESCRIPTION

Disclosed are various approaches for using augmented reality to assist in training and evaluating students. Using augmented reality, a student is able to assume the first-person perspective of his or her instructor. Likewise, an instructor can also assume the first-person perspective of his or her student. As a result, the student is able to view the motions of the instructor from the perspective of the instructor.

The student can them attempt to copy or mimic the body motions or movements of the instructor. For example, if the student were attempting to improve his or her golf-swing, the student may attempt to move his or her arms in the manner that matches how the instructor moved his or her arms. In some embodiments, the body motions or body parts of the instructor may be overlaid or otherwise presented to the student. This can allow the student to see whether he or she is successfully mimicking the body motions of the instructor. For example, if the student is trying to perfect his or her golf-swing, the student could see whether his or her arms were following the motion demonstrated by his or her instructor.

Similarly, the instructor can view the motions of the student from the perspective of the student. For example, the instructor could watch, from the first-person perspective of the student, how the student was executing or performing various techniques or body motions. The instructor could further evaluate the student by attempting to mimic the recorded body motions of the student.

Use of the disclosed approaches improves instruction time by allowing users to more quickly practice a correct technique. As a user visualizes the proper technique from a first-person perspective, they can attempt to mirror the proper technique to learn more quickly how the proper technique feels when performed. By performing repetitions where the student mirrors the proper technique from the first-person perspective, the user can more quickly master a technique compare to previous approaches where the user may have practiced the technique while slowly adjusting his or her body to refine the technique.

The disclosed approaches take advantage of proprioception—the sense of the relative position of one's own body parts being employed in a body motion. When a user's proprioception is mismatched with a user's visual perception of his or her own body parts, the user naturally wants to match his or her body motions and movements to match what he or she sees as his or her body motions. The use of virtual reality techniques allows for a user's visual perception of his or her body parts in motion to be replaced with the visual perception of another user's body parts. As a result, if a user is visually perceiving the positions and movements of an instructor's body parts (e.g., a dance instructor's movements in a dance technique), and the visual perception fails to match the user's proprioception of the position of his or her own body parts, the user will naturally begin to reposition his or her own body parts so that his or her proprioception matches his or her visual perception.

In the following discussion, a general description of the system and its components is provided, followed by a discussion of the operation of the same. Although a number of examples are provided to illustrate various embodiments of the present disclosure, it should be noted that these examples are not intended to limit the scope of the application to specific implementations. Instead, the examples provided herein are intended to illustrate the various principles underlying the various embodiments of the present disclosure.

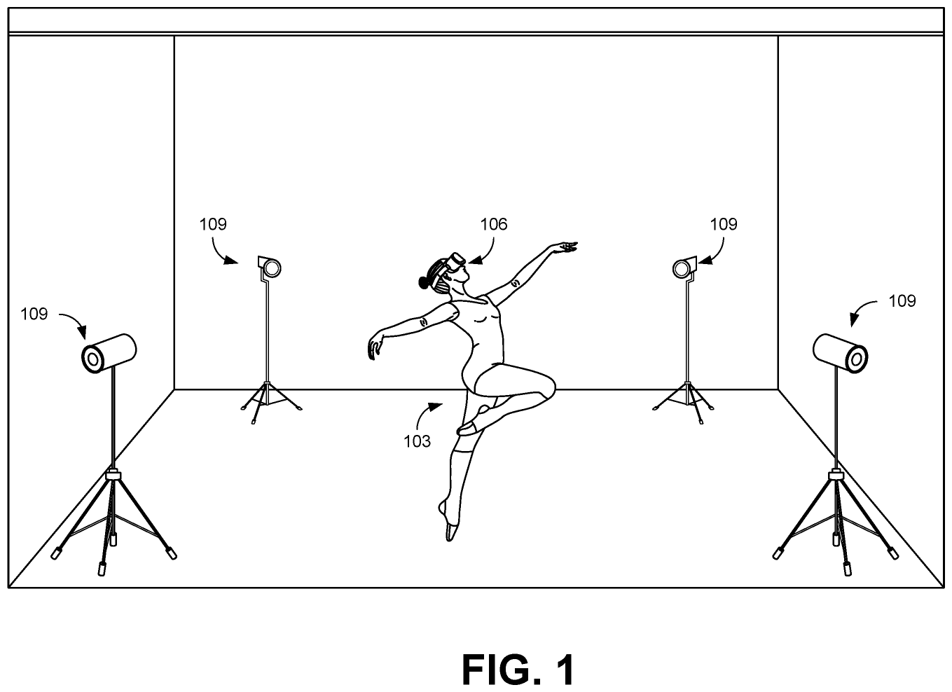

As illustrated in FIG. 1, a user 103 can wear a headset 106 while performing one or more motions. In the illustrated example, a dancer is performing a dance routine. Surrounding the dancer 106 are one or more cameras 109 that capture the movements of the dancer from various angles. The headset 106 may include a camera that captures a first-person perspective of what the user 103 views with his or her eyes. The headset 106 can also include video playback capabilities or audio playback capabilities. In these instances, the headset 106 may be a virtual reality or augmented reality headset.

The video recorded from the headset 106 and the cameras 109 can then be converted into a virtual reality model of the user 103. The virtual reality model may be generated using motion capture, object recognition, motion recognition, or other computer-vision techniques. Once generated, the virtual reality model can be sent to a headset 106, such as a virtual reality or augmented reality headset. A user 103 wearing the headset 106 to view the virtual model can see not only what the user saw when they were recording the first person perspective, but also what was captured by the cameras 109.

For example, a student performing a dance technique, which requires specific placement of the hands, arms, legs, torso, and head of the dancer, may wish to see if their arms are in the right place or their legs are in the right place. After assuming a pose, the dancer may view the placement of their hands and feet, relative to the placement of the instructor's hands and feet captured by the cameras 109 to generate a virtual reality model.

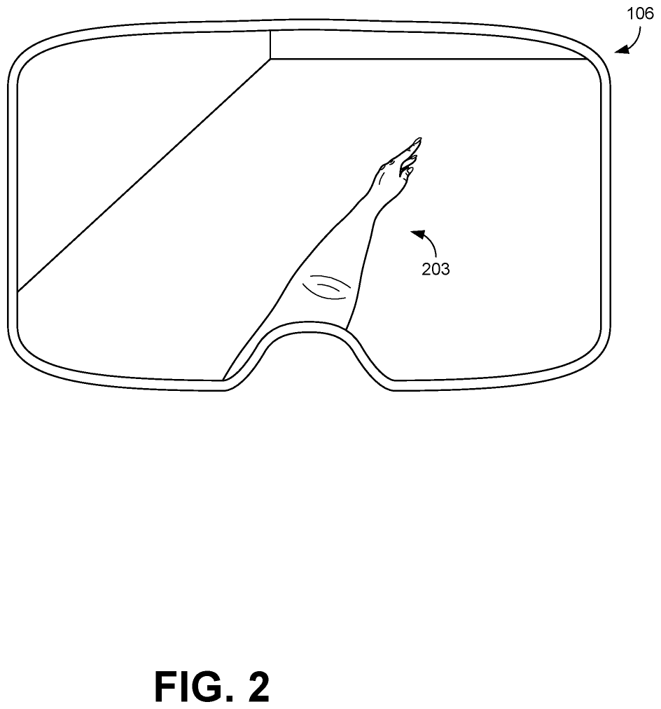

FIG. 2 illustrates a first, simple example of the use of the headset 106 according to various embodiments of the present disclosure. A user, when wearing the headset 106, is provided with a first-person view of what was recorded by another user. For example, an instructor may be provided with a first-person view of what is seen by a student or vice versa. As illustrated, the wearer is provided with a view of an appendage 203 of the user who was wearing the headset 106 to make the recording. The wearer could then attempt to match the position of their own arm with the appendage 203 viewed in the headset.

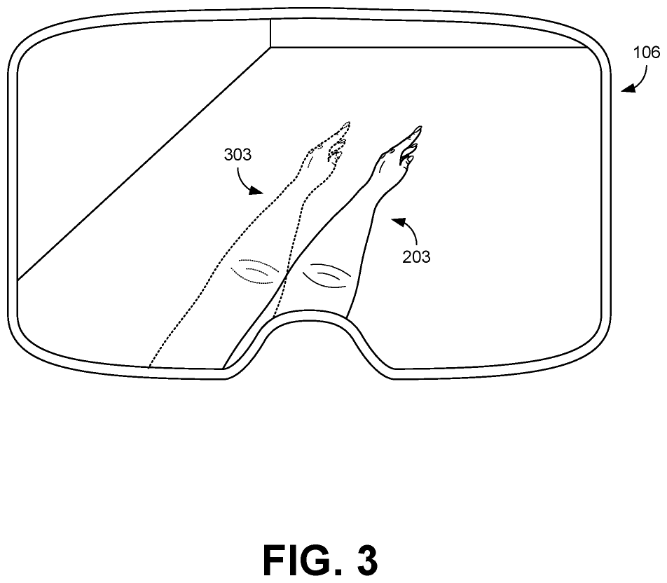

FIG. 3 illustrates a second example of the use of the headset 106 according to various embodiments of the present disclosure. Like the example in FIG. 2, a user, when wearing the headset 106, is provided with a first-person view of what was recorded by another user. The wearer is provided with a view of an appendage 203 of the user who was wearing the headset 106 to make the recording. The wearer could then attempt to match the position of their own arm with the appendage 203 viewed in the headset.

To assist the wearer, an overlay 303 of the wearer's own arm is also depicted in the headset 106. As shown, the overlay 303 is at a different point than the appendage 203. For example, a student's own arm may be at the incorrect position, resulting in the overlay 303 of the student's arm indicating that it is at a different position than the arm 203 of the instructor who made the recording. If the student were to move his or her arm to match the position of the arm 203 of the instructor, the overlay 303 would be shifted accordingly. This can allow the student to learn how to match the technique depicted by the instructor. Likewise, an instructor can be more able to review a student, by viewing where the student's appendage or arm 203 is located relative to where the overlay 303 representing the instructor's arm should be.

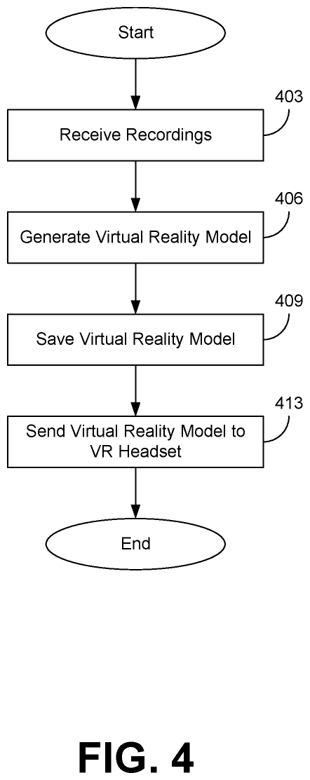

Referring next to FIG. 4, shown is a flowchart that provides an example of the many different types of functional arrangements that may be employed to implement the operation of the portion of the present disclosure as described herein. As an alternative, the flowchart of FIG. 4 may be viewed as depicting an example of elements of a method implemented using one or more computing devices.

Beginning with box 403, recordings are received from one or more image or video recording devices, such as video cameras. The recordings may be received across a network (e.g., from network connected devices) or uploaded from a non-transitory computer-readable medium (e.g., a secure digital (SD) card, flash memory drive, optical media, etc.). The recordings may have been generated as part of a motion capture recording, or from a headset 106 with video recording capabilities.

Next at box 406, a virtual reality model can be generated or synthesized from the recordings received at box 403. The virtual reality model can include a data representation of what a user wearing a headset 106 would see and/or hear. A simple virtual reality model may include only a single video-recording from a headset 106 representing the first-person perspective of the individual wearing the headset 106.

However, more complicated virtual reality models can be generated from video obtained from a combination or plurality of cameras. For example, a video from the first-person perspective may be used as the basis for the virtual reality model. However, additional data from other cameras recording the user may also be used to supplement the first-person perspective with additional data. For instance, data from other cameras may allow for a three-dimensional model or avatar to be generated, allowing one to view, from a first-person perspective, other actions or activities not recorded by the user wearing the headset 106 to record the video from the first-person perspective. As a result, a student wearing a headset 106 could view not just what was recorded from the teacher's first-person perspective when the teacher was wearing the headset 106 (e.g., the teacher's hands), but also “look around” to see what the instructor was doing with other body parts (e.g., the teacher's feet).

Then at box 409, the virtual reality model is saved to a data store. This allows the virtual reality model to be reused or edited at later times.

Subsequently at box 413, the virtual reality model is later sent to a headset 106, such as a virtual reality or augmented reality headset 106. This could be done, for example, in response to a request received from a headset 106 across a network connecting the headset 106 to the computing device hosting the data store.

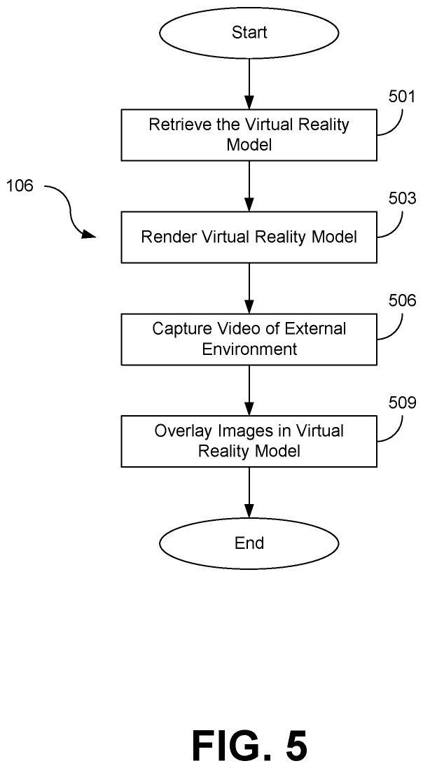

Referring next to FIG. 5, shown is a flowchart that provides an example of the many different types of functional arrangements that may be employed to implement the operation of the portion of the present disclosure as described herein. For example, the flowchart may represent machine-readable instructions or an application executed by a virtual reality headset 106 or by a computing device connected to the virtual reality headset 106. As an alternative, the flowchart of FIG. 5 may be viewed as depicting an example of elements of a method implemented using one or more computing devices.

Beginning with box 501, the headset 106 can retrieve the virtual reality model from the data store that is storing the virtual reality model. For example, the headset 106 may send a request across a network to a server that stores the virtual reality model and receive a copy of the virtual reality model in response. As another example, the headset 106 may send a request to a computing device attached to or in data connection with the headset 106 to retrieve a copy of the virtual reality model from local storage on the computing device.

Proceeding to box 503, the headset 106 can render or otherwise display the virtual reality model for the user. As a result, the user is able to perceive the world and actions that were recorded previously using the headset 106 and one or more cameras 109. This could, for example, correspond to a student viewing a recording of a teacher performing a technique (e.g., dance technique, golf swing, baseball swing, playing a musical instrument, etc.) or a teacher viewing a student's attempts at a technique to evaluate and provide feedback for the student.

Next at box 506, the headset 106 can capture video from the first-person perspective of the user wearing the headset 106. The video capture can be performed simultaneously with the rendering or display of the virtual reality model. For example, while a user is viewing a golf-swing depicted in the virtual reality model, the user may try to move his or her arms to mirror the golf-swing. The user's arms may be recorded as they move through the field of vision of a camera mounted to the headset 106.

Then at box 509, can overlay one or more images of objects captured in the video at box 506. For example, the headset 106 or a computing device attached to the headset 106 may perform object recognition using various computer vision techniques to identify specific objects in the video captures at box 506. Select objects in the captured video may then be displayed in the virtual reality model being rendered, as previously depicted in FIG. 3. In some instances, the additional objects may be depicted in a semi-transparent manner to allow two objects to be viewed on top of one another or in the same space as one another. For example, if a student were trying to replicate the golf swing of an instructor, the student's arms may be overlaid or superimposed on the virtual reality model being depicted in order for the student to see if he or she is accurately duplicating the instructor's technique.

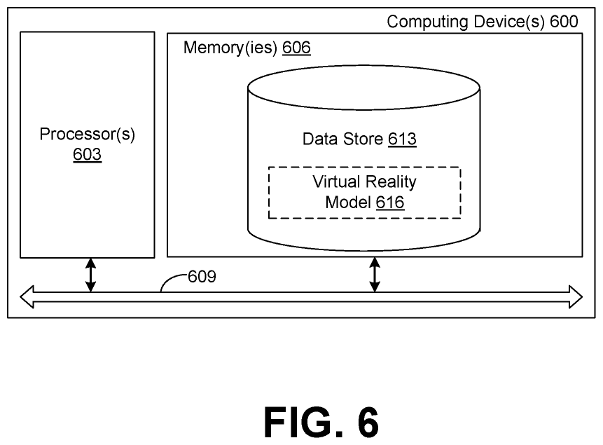

With reference to FIG. 6, shown is a schematic block diagram of a computing device 600 used to implement various embodiments of the present disclosure. Each computing device 600 includes at least one processor circuit, for example, having a processor 603 and a memory 606, both of which are coupled to a local interface 609. To this end, each computing device 600 may include, for example, at least one server computer or like device. The local interface 609 may include, for example, a data bus with an accompanying address/control bus or other bus structure as can be appreciated.

Stored in the memory 606 are both data and several components that are executable by the processor 603. In particular, stored in the memory 606 and executable by the processor 603 are the machine-readable instructions used to implement the methods depicted in FIG. 4 or FIG. 5, and potentially other applications. Also stored in the memory 606 may be a data store 613, which may store one or more virtual reality models, such as the virtual reality model 616, and other data. In addition, an operating system may be stored in the memory 606 and executable by the processor 603.

It is understood that there may be other applications that are stored in the memory 606 and are executable by the processor 603 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

Also, the processor 603 may represent multiple processors 603 or multiple processor cores and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606. The local interface 609 may include additional systems designed to coordinate this communication, including, for example, performing load balancing. The processor 603 may be of electrical or of some other available construction.

Although applications and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 4 and 5 show the functionality and operation of an implementation of portions of an application. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor 603 in a computer system or other system. The machine code may be converted from the source code through various processes. For example, the machine code may be generated from the source code with a compiler prior to execution of the corresponding application. As another example, the machine code may be generated from the source code concurrently with execution with an interpreter. Other approaches can also be used. If embodied in hardware, each block may represent a circuit or a number of interconnected circuits to implement the specified logical function or functions.

Although the flowcharts of FIGS. 4 and 5 show a specific order of execution, it is understood that the order of execution may differ from that which is depicted. For example, the order of execution of two or more blocks may be scrambled relative to the order shown. Also, two or more blocks shown in succession in FIGS. 4 and 5 may be executed concurrently or with partial concurrence. Further, in some embodiments, one or more of the blocks shown in FIGS. 4 and 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as, for example, a processor 603 in a computer system or other system. In this sense, the logic may include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 600, or in multiple computing devices in the same computing environment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiments without departing substantially from the spirit and principles of the disclosure. All such modifications and variations are intended to be included herein within the scope of this disclosure and protected by the following claims.

1. A system, comprising:
a computing device comprising a processor and a memory; and
machine readable instructions stored in the memory that, when executed by the processor, cause the computing device to at least:
receive a video recording captured by camera mounted to a first user, the video recording comprising a plurality of body movements of the first user;
generate a virtual reality model from the video recording; and
send the virtual reality model to a virtual reality headset mounted to a second user.

2. A system, comprising:
a computing device comprising a processor and a memory; and
machine readable instructions stored in the memory that, when executed by the processor, cause the computing device to at least:
receive a plurality of video recordings of a first user from a plurality of video cameras;
generate a virtual reality model from the plurality of video recordings; and
send the virtual reality model to a virtual reality headset mounted to the head of a second user.

3. The system of claim 2, wherein at least one of the plurality of video cameras is mounted to the first user and a respective one of the plurality of video recordings comprises a first-person view of a plurality of body movements of the first user.

4. The system of claim 2, wherein the machine readable instructions that cause the computing device to generate the virtual reality model further cause the computing device to synthesize the plurality of video recordings to form the virtual reality model, wherein the virtual reality model is viewable from any point of view of the second user.
